(19) United States
(12) Patent Application Publication
(10) Pub. No.: US 2010/0047426 A1
(43) Pub. Date: Feb. 25, 2010

(54) METHOD FOR MODULATING THE TASTE OF MATERIAL COMPOSITIONS CONTAINING AT LEAST ONE HIGH INTENSITY SWEETENER (HIS)

(75) Inventors: Markus Matuschek, Weinheim (DE); Martin B. Jager, Enkenbach-Alsenborn (DE); Alice Kleber, Bensheim (DE); Michael Krohn, Lorsch (DE); Holger Zinke, Zwingenberg (DE)

Correspondence Address: CONNOLLY BOVE LODGE & HUTZ, LLP, P O BOX 2207, WILMINGTON, DE, 19899, US

(73) Assignee: BASF SE, Ludwigshafen (DE)

(21) Appl. No.: 12/443,237

(22) PCT Filed: Feb. 25, 2008
(86) PCT No.: PCT/EP08/52272

§ 371 Date: Mar. 27, 2009

(30) Foreign Application Priority Data
Feb. 23, 2007 (EP) 07102977.1
Nov. 26, 2007 (EP) 07121532.1

(51) Int. Cl. A23L 1/22; A23L 1/236

(52) U.S. Cl. 426/535

(57) ABSTRACT

Process for taste modulation of compositions of matter which comprise at least one High Intensity Sweetener HIS, which comprises adding at least two azo compounds in a total concentration of 0.1 to 30 ppm or 0.1 to 30 mg/l as taste modulators to a composition of matter which comprises at least one HIS.

### FIELD OF THE INVENTION

The present invention relates to a novel process for taste modulation, in particular for reduction of bitter taste and aftertaste of compositions of matter which comprise at least one High Intensity Sweetener (HIS).

### PRIOR ART

Compositions of matter such as foods, drinks, articles consumed for pleasure, sweetening agents, animal feeds, cosmetics and pharmaceuticals frequently comprise taste substances which are in principle unwanted or are too dominant or too low in the intensity in which they are present. In the sector of sweeteners, frequently, in addition to the sweet taste impressions, further taste impressions such as, for example, a metallic, chemical, bitter or synthetic taste or aftertaste occurs, which adversely affect the overall taste impression of the composition to be sweetened. In the context of the present invention, taste is taken to mean the immediate taste impression which is formed while the composition is situated in the mouth. Aftertaste is taken to mean the taste perception after swallowing, in particular after a waiting time of about 30 seconds.

For example, caffeine in tea or coffee, and also hop extracts in beer, are natural bitter substances which, however, in too high a concentration cause an adverse taste impression. In special bitter drinks such as, for example, tonic water or bitter lemon, a characteristic bitter taste caused by the additive quinine is desired to a particular extent. On the other hand, in particular the bitter taste or aftertaste of many artificial sweetening agents, such as, for example, acesulfam K (ACK) and saccharin, is an undesirable sidetaste of the sweetening agent in other soda drinks. Fruit juices, in particular orange juice, also suffer from impairment of the taste by, e.g., flavonoid glycosides, which have a bitter taste. Many pharmaceutical active compounds, in particular ibuprofen, also have a strongly bitter taste which leads to reduction in acceptance when the active compound is taken.

For reduction of the natural bitter taste, for example of tea, coffee or orange juice, these foods, drinks and articles consumed for pleasure are either enzymatically treated in order to destroy the bitter tasting substances, or the bitter substance is removed by decaffeination in the case of caffeine in tea and coffee.

A further possibility of modifying the taste impression is addition of taste modulators to the desired foods, drinks, articles consumed for pleasure, animal feeds, sweetening agents, cosmetics and pharmaceuticals.

It is therefore desirable to find substances which suppress or reduce the unpleasant taste impressions, and also amplify in a targeted manner desired taste impressions or at least do not adversely affect them.

In particular in the sector of pharmaceutical active compounds, a great number of substances which, in particular, modify bitterness, are known. Thus, for example, the bitter taste of ibuprofen is masked by polylysine and polyarginine (cf. international patent application WO 2003/086293), by meglumine salt (cf. U.S. Pat. No. 5,028,625), by sodium chloride or sodium-saccharin (cf. international patent application WO 2003/0475550) or by hydroxypropyl-beta-cyclodextrin or chewable methacrylic acid copolymers (cf. Modifying Bitterness, Mechanism, Ingredients And Applications, Glenn Roy, 1997) in order to facilitate intake by patients. The bitterness of caffeine may also be reduced by a multiplicity of taste modulators such as, for example, glutamic acid, dicalcium disalicylate, starch, lactose, manitol and also by phosphatidic acid and beta-lactoglobulin (cf. Glenn Roy, 1997) and in addition by hydroxybenzamides, in particular hydroxybenzoic acid vanillylamide (cf. Ley et al., Journal of Agricultural & Food Chemistry, 2006).

Further substances which have been used for reduction of a bitter taste in general and in particular in pharmaceuticals and foods are lecithin, ascorbate and citrate (cf. Japanese patent application JP 2001226293), esters of mono- or diglycerides such as glycerol monostearate and polycarboxylic acids such as succinic acid (cf. European patent application EP 0 732 064 A1), hydroxyflavanones (cf. European patent application EP 1 258 200 A1), 2-phenyl-4-chromanone derivatives (cf. German patent application DE 101 22 898), sodium sulfate hydrate (cf. Japanese patent application JP 02025428). In addition, U.S. Pat. No. 5,637,618 discloses the use of benzoic acid derivatives for reduction of the bitter taste in drinks and also of sweetening agents and of potassium chloride. The bitter taste of potassium chloride is also inhibited using 2,4-dihydroxybenzoic acid, carrageenan and thaumatin (cf. Glenn Roy, 1997; U.S. Pat. No. 5,637,618 and also Japanese patent applications JP 04262758 and JP 07083684).

However, the known taste modulators are not completely satisfactory, in particular when the intention is to use them for reduction of the bitter taste of compositions of matter such as, for example, foods, drinks, articles consumed for pleasure, sweetening agents, animal feeds, cosmetics and pharmaceuticals which comprise at least one HIS, but in particular of HIS-comprising soft drinks. In this case their bitterness-reducing activity is frequently insufficient. If, for this reason, the concentration of the known taste modulators is increased in order to achieve sufficient activity, unwanted physical and/or chemical interactions with the remaining components of the respective compositions and/or adverse effects, in particular impairment up to complete distortion of the characteristic taste impression thereof can occur.

The joint use of azo dyes such as Yellow 6 (E110) in a concentration of 36 mg/l and Red 40 (E129) in a concentration of 2 mg/l for coloring soft drinks which comprise ACK as HIS is known. One example of such a product is Diet Sunkist® Orange Soda. The azo dyes serve to color the drink. It is not known whether the azo dyes used also cause a reduction of the bitter taste and aftertaste of ACK.

The prior European patent application with the application number 07102977.1 describes the use of azo dyes as taste modulators for compositions of matter which comprise at least one HIS. However, only one azo dye is ever used in any given composition of matter.

### OBJECT OF THE INVENTION

Accordingly, the object of the present invention was to find a novel process for taste modulation, in particular for reduction of bitter taste and aftertaste of compositions of matter which comprise at least one High Intensity Sweetener (HIS), in particular of foods, drinks, articles consumed for pleasure, sweetening agents, animal feeds, cosmetics and pharmaceuticals, preferably foods, drinks, articles consumed for pleasure, sweetening agents, animal feeds, cosmetics and pharmaceuticals which comprise at least one HIS.

The novel process for taste modulation must have the effect that the taste modulators used do not cause any unwanted physical and/or chemical interactions with the remaining components of the respective compositions, in particular the foods, drinks, articles consumed for pleasure, sweetening agents, animal feeds, cosmetics and pharmaceuticals, and the characteristic taste impression is not adversely affected, in particular is not impaired or completely distorted.

In particular, the novel process should make it possible to significantly reduce the bitter taste and the bitter aftertaste of compositions of matter which comprise at least one HIS using even very small amounts of taste modulators.

### Solution According to the Invention

Accordingly, the novel process for taste modulation of compositions of matter which comprise at least one High Intensity Sweetener HIS has been found in which at least two azo compounds are added in a total concentration of 0.1 to 30 ppm or 0.1 to 30 mg/l as taste modulators to a composition of matter which comprises at least one HIS.

Hereinafter, the novel process for taste modulation of compositions of matter is termed “process according to the invention”.

### Advantages of the Invention

In relation to the prior art, it was surprising, and not predictable by a person skilled in the art, that the object of the present invention could be solved by means of the process according to the invention.

It was surprising that the process according to the invention had the effect that the taste modulators used did not cause any unwanted physical and/or chemical interactions with the remaining components of the respective compositions of matter which comprised at least one HIS, in particular the foods, drinks, articles consumed for pleasure, sweetening agents, animal feeds, cosmetics and pharmaceuticals, and their characteristic taste impression was not adversely affected, in particular was not impaired or even completely distorted.

In particular, the process according to the invention made it possible to significantly reduce the bitter taste and the bitter aftertaste of compositions of matter which comprised at least one HIS using even very small amounts of taste modulators.

These surprisingly small amounts also did not adversely affect the color impression of the compositions of matter, which, in particular in the case of colored soft drinks, was a very particular advantage.

It was especially surprising that the taste modulation of a given composition of matter which comprised at least one HIS by the process according to the invention was outstandingly reproducible, which, precisely in regard to the production of mass products such as foods, drinks, articles consumed for pleasure, sweetening agents, animal feeds, cosmetics and pharmaceuticals, is a very particular advantage.

### DETAILED DESCRIPTION OF THE INVENTION

The process according to the invention relates to the taste modulation, in particular the reduction of the bitter taste and the bitter aftertaste, of compositions of matter which comprise at least one High Intensity Sweetener (HIS).

Preferably, the compositions of matter are foods, drinks, articles consumed for pleasure, sweetening agents, animal feeds and cosmetics, preferably in foods, drinks, articles consumed for pleasure, sweetening agents, animal feeds, cosmetics and pharmaceuticals. Preferably, the drinks are soft drinks, particularly preferably caffeine-comprising soft drinks, in particular cola drinks.

The compositions of matter comprise at least one High Intensity Sweetener HIS as sweetening agent or sweetener. HIS is taken to mean compounds of synthetic or natural origin which have no physiological calorific value, or negligible calorific value in relation to the sweetening power (non-nutritive sweeteners) and have a sweetening power many times higher than sucrose. The sweetening power of a compound is given by the dilution at which it tastes just as sweet as a sucrose solution (isosweet solution; 0.1 M=4%), i.e. a solution of a sweetener which is diluted 500 times has an isosweet taste like a sucrose solution when the sweetener has a sweetening power of 500.

Examples of suitable HISs are known from Römpp Online 2007, “Süβstoffe” [Sweeteners]. Preferably, the HISs are selected from the group consisting of acesulfame-potassium (ACK), aspartame (ASP), saccharin and salts thereof, cyclamate and salts thereof, aspartame-acesulfame salt, sucralose, thaumatin, stevia, stevioside and neohesperidin dihydrochalcone, preferably ACK, ASP, saccharin and sucralose, particularly preferably ACK and saccharin, in particular ACK.

Preferably, the composition of matter is a low-sugar composition which comprises less than 10 g, preferably less 1 g, of sugar per liter or per kg of composition, in particular a sugar-free composition. Sugars are taken to mean in the present case, in particular, but not exclusively, mono- and disaccharides.

Advantageously, the composition of matter is a composition having less than 100 kJ, preferably less than 10 kJ, per liter or per kg of composition.

Advantageously, the composition of matter is a carbohydrate-free, in particular starch-free, composition.

Preferably, the composition of matter is a low-fat composition which comprises less than 1 g of fat per liter or per kg of composition, in particular a fat-free composition.

The low-sugar and/or low-fat, in particular the sugar-free and/or fat-free compositions, are preferably an ACK-sweetened composition.

In the context of the process according to the invention, at least two, in particular two azo compounds which each have at least one azo group are further added to the compositions of matter. Preferably, the azo compounds are soluble in water.

The total amount or total concentration of the azo compounds is 0.1 to 30 ppm, preferably 0.5 to 20 ppm, and in particular 1 to 10 ppm, in each case based on the total amount of a composition of matter. If the composition of matter is a liquid, the azo compounds are used in a concentration of 0.1 to 30 mg/l, preferably 1 to 20 mg/l, and in particular 1 to 10 mg/l.

These small effective total amounts or total concentrations do not result in a change in the color impression of the compositions of matter, or only to a very slight extent, negligible extent, which yet again underpins the particular advantageous nature of the process according to the invention.

In this case the weight ratio of the individual azo compounds to each other can likewise be varied widely and very well matched to the requirements of the individual case. If two azo compounds are used, which is preferable according to the invention, the weight ratio of the azo compounds to each other is preferably 10:1 to 1:10, more preferably 5:1 to 1:5, and in particular 2:1 to 1:2.

Preferably, the azo groups of the azo compounds are linked to aryl groups and/or aryl groups having heteroatoms, more preferably aryl groups, in particular phenyl groups and/or naphthyl groups. In this case, one or more azo groups can be present in one azo compound. These azo groups can be linked independently of one another to aryl groups and/or aryl groups having heteroatoms, preferably aryl groups, in particular phenyl groups and naphthyl groups.

Preferably, at least one aryl group is at least monosubstituted. In this case one aryl group of an azo group can be unsubstituted while the other is polysubstituted.

Examples of suitable substituents are sulfonic acid groups, nitro groups, alkyl groups, carboxyl groups, hydroxyl groups, ester groups, ether groups, primary and secondary amino groups, amide groups, nitrile groups and halogen atoms, preferably sulfonic acid groups, hydroxyl groups and nitro groups, in particular sulfonic acid groups and hydroxyl groups.

Preferably, the azo compounds are selected from the group consisting of the compounds 1 to 112 listed hereinafter. The azo compound can be ionic or nonionic and can be present in charged or uncharged form.

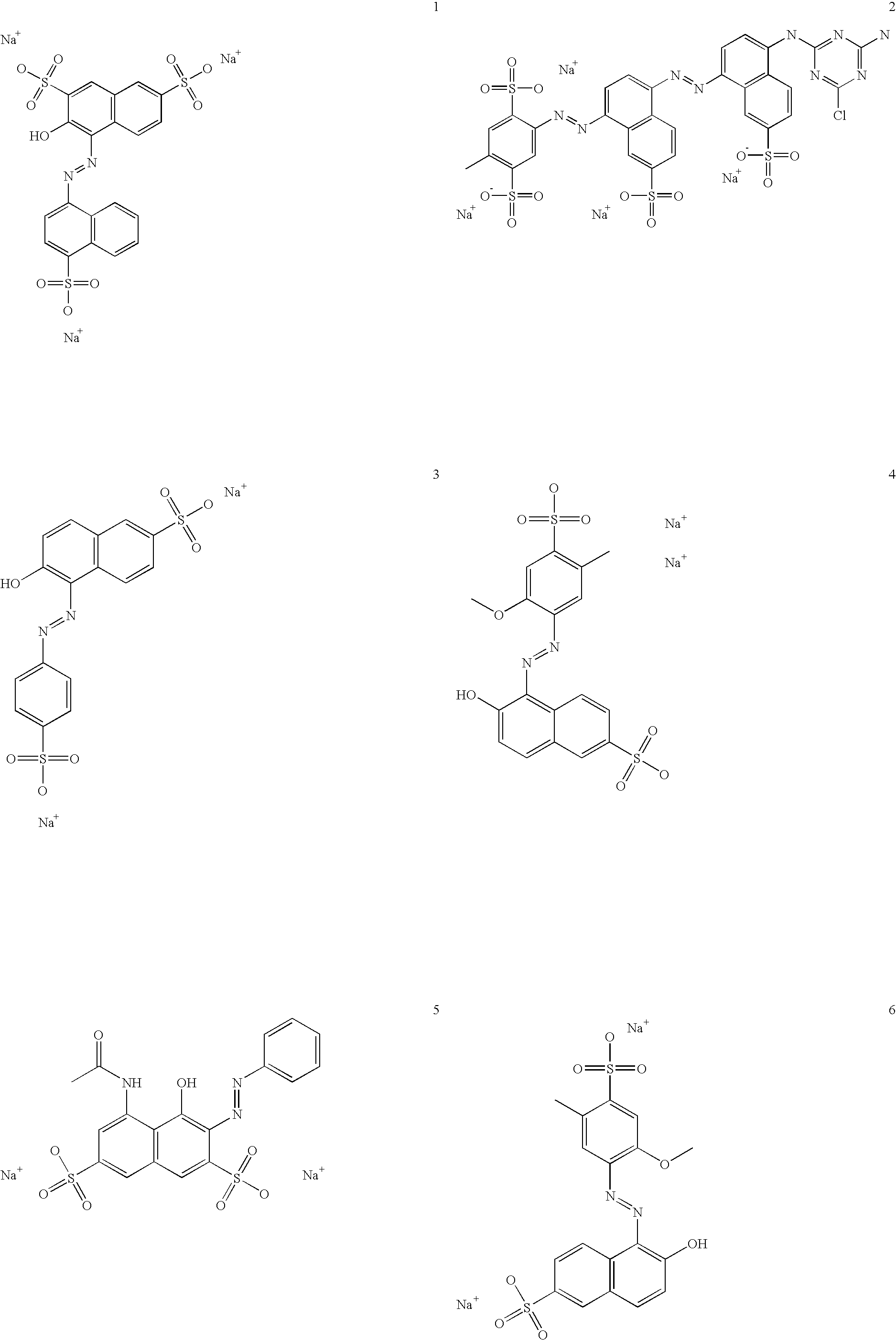

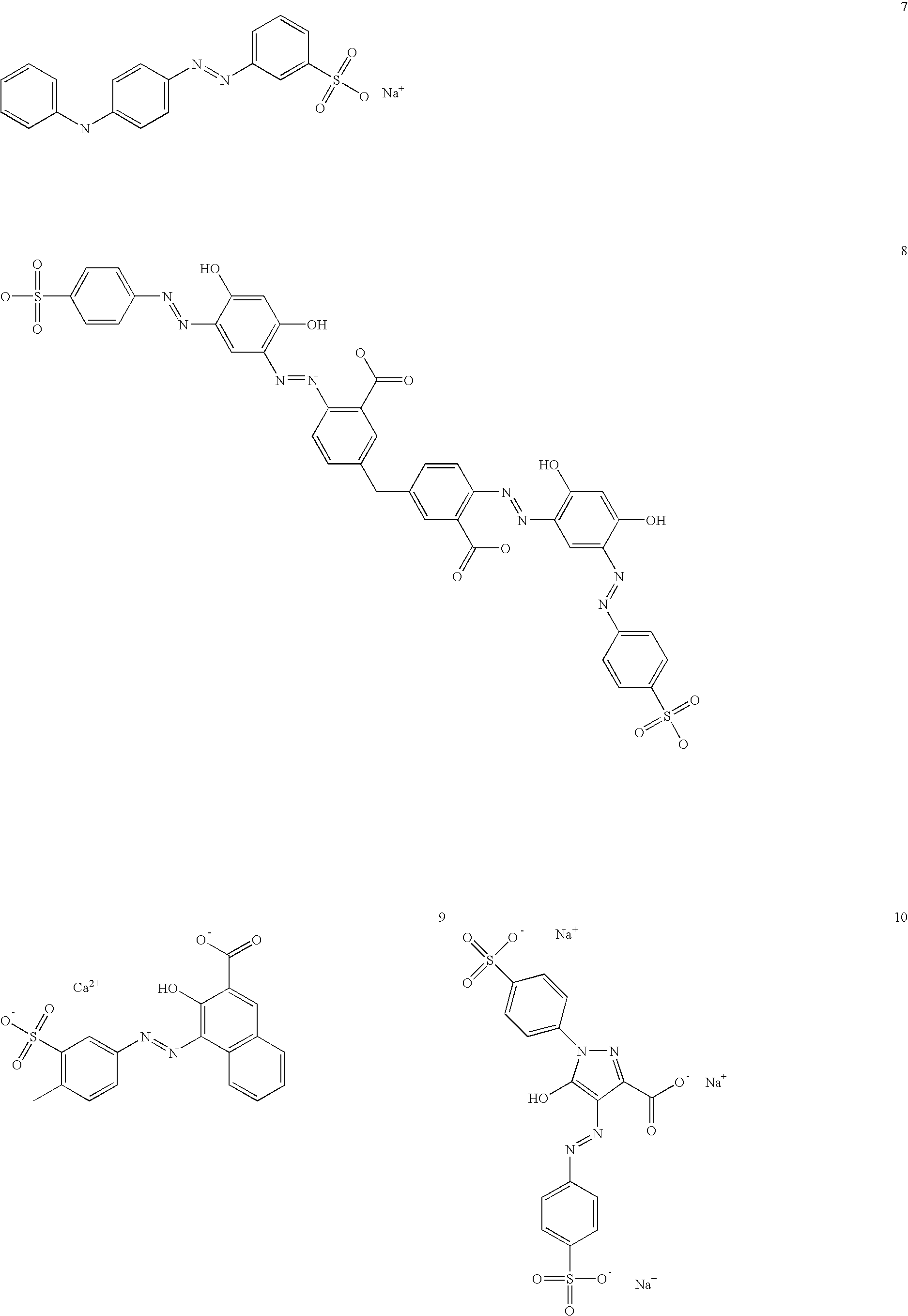

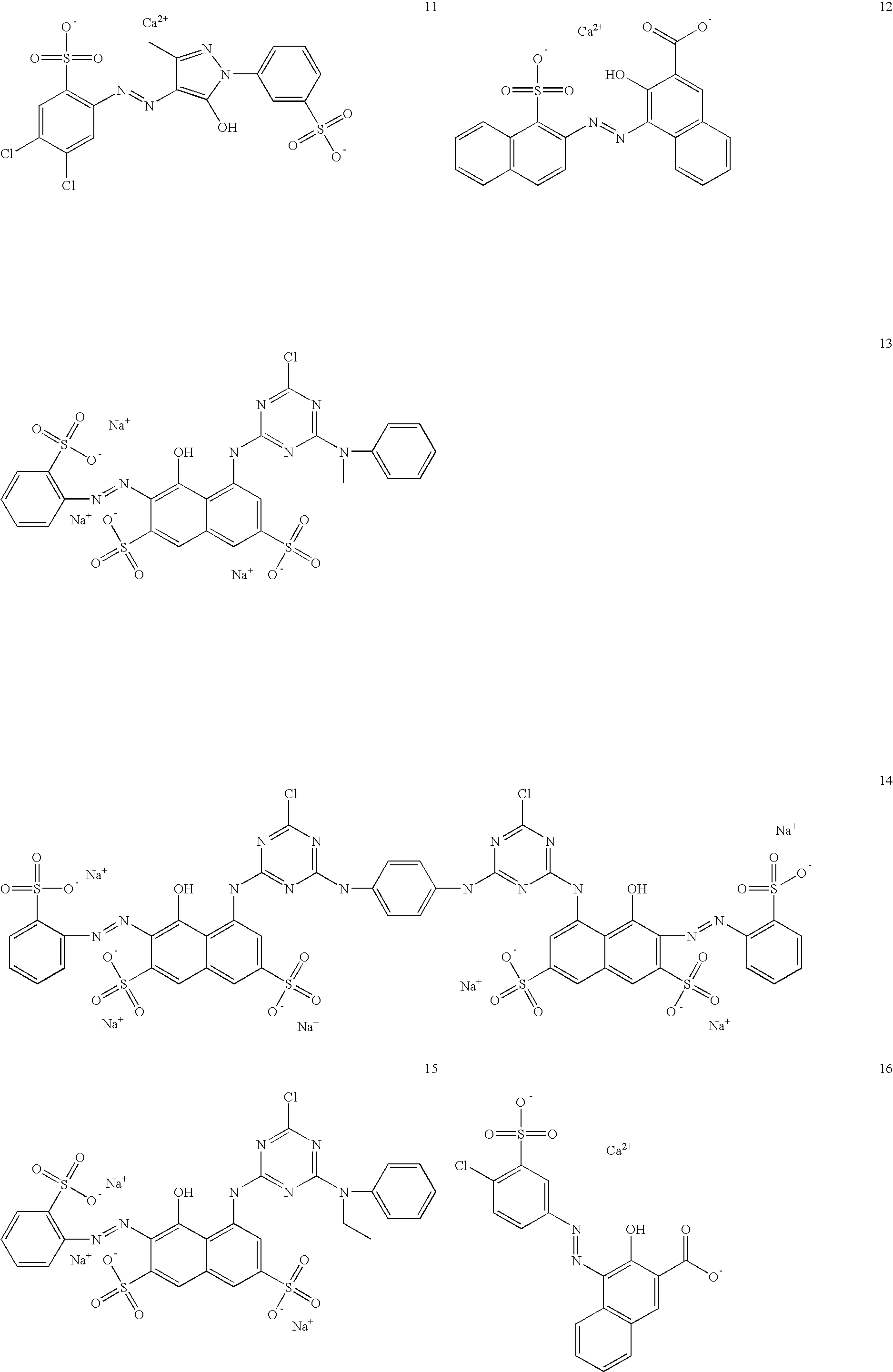

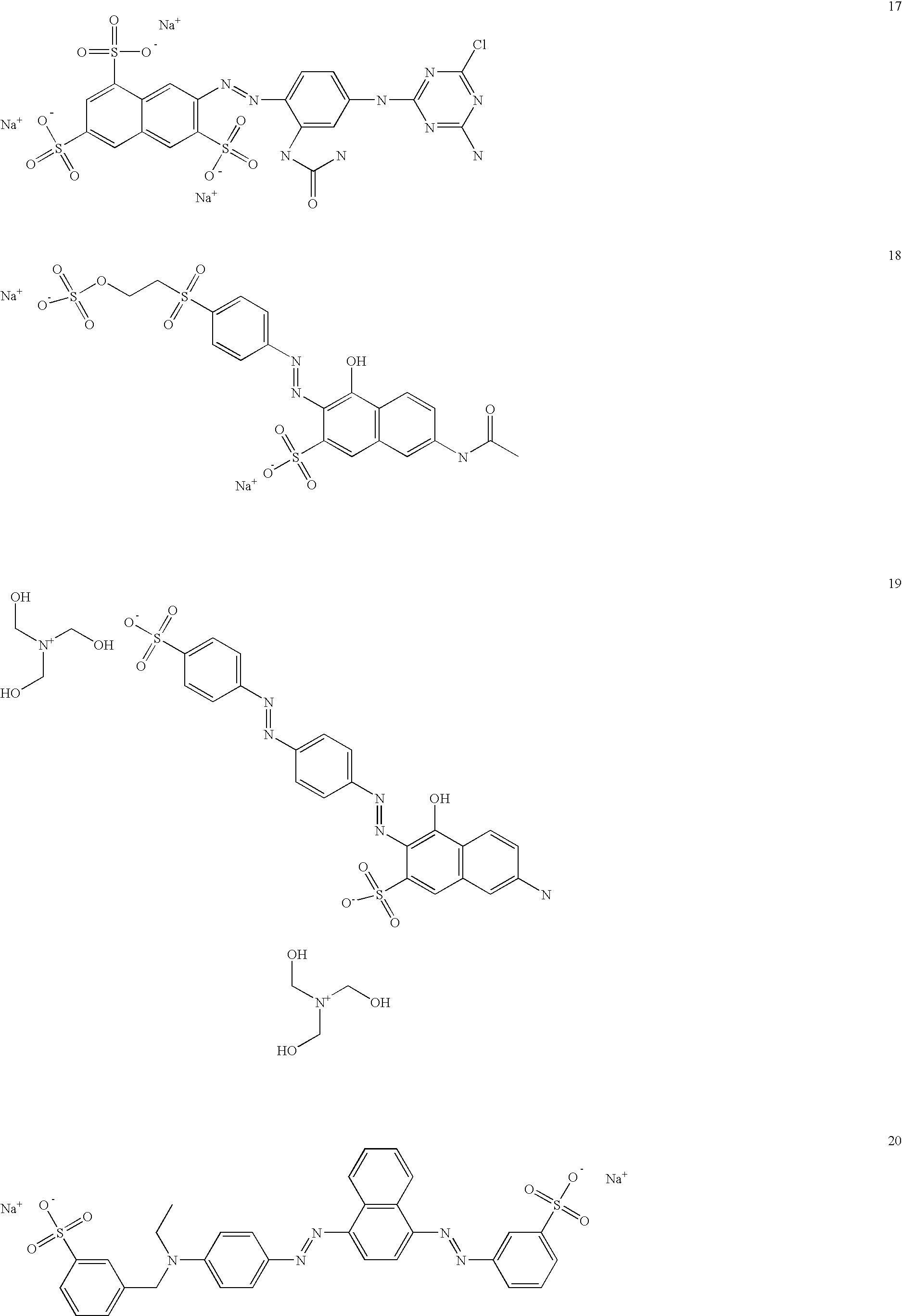

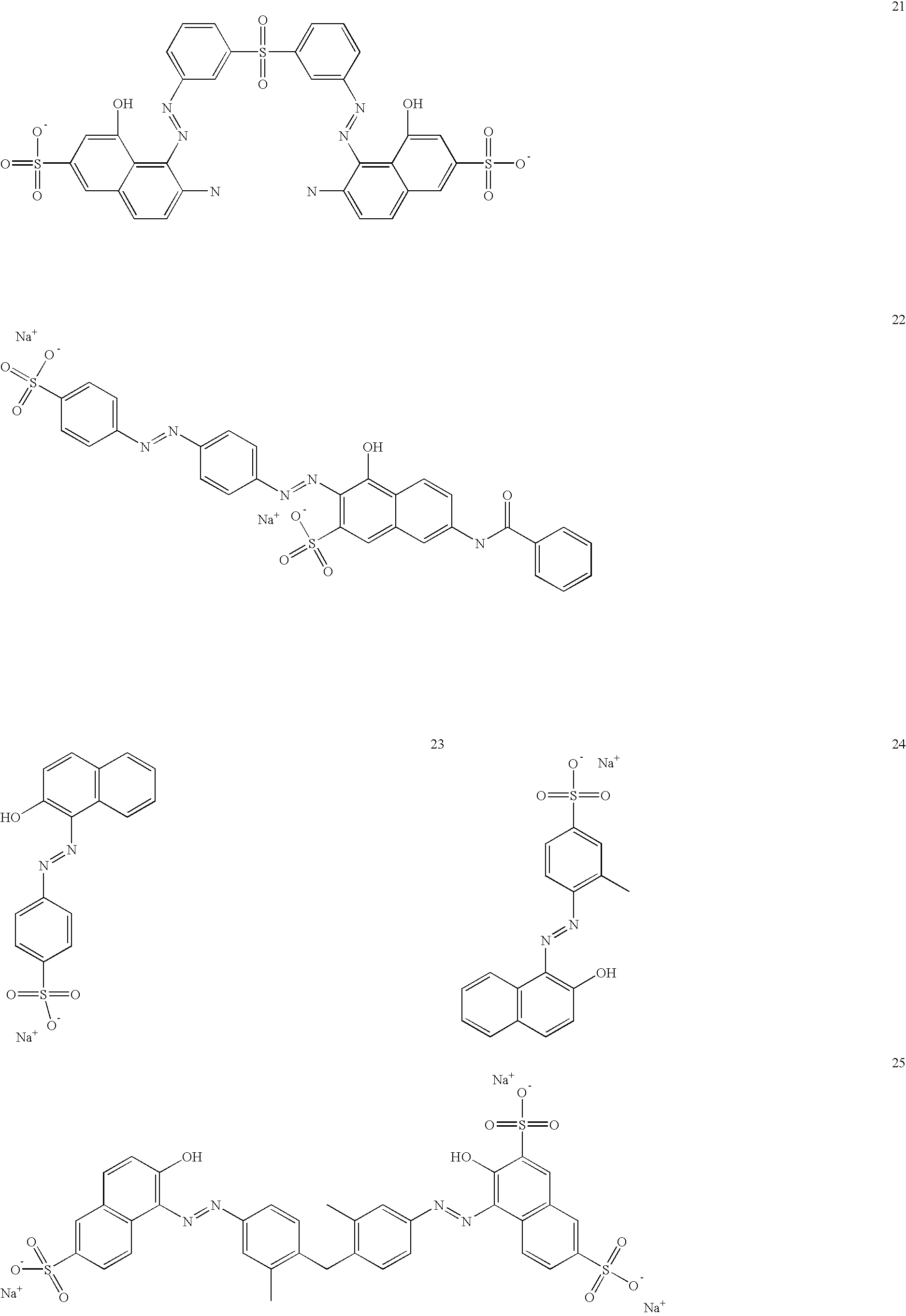

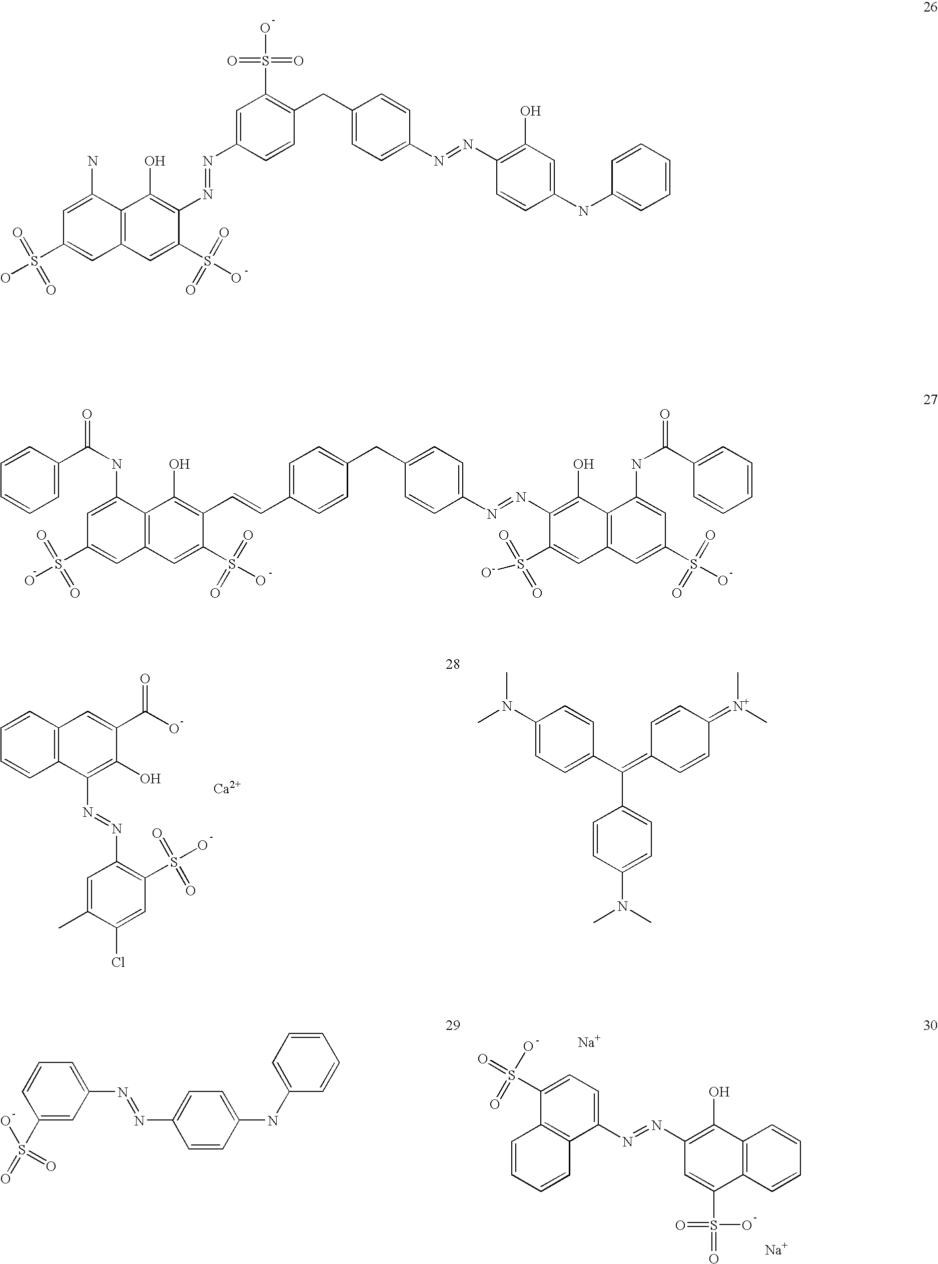

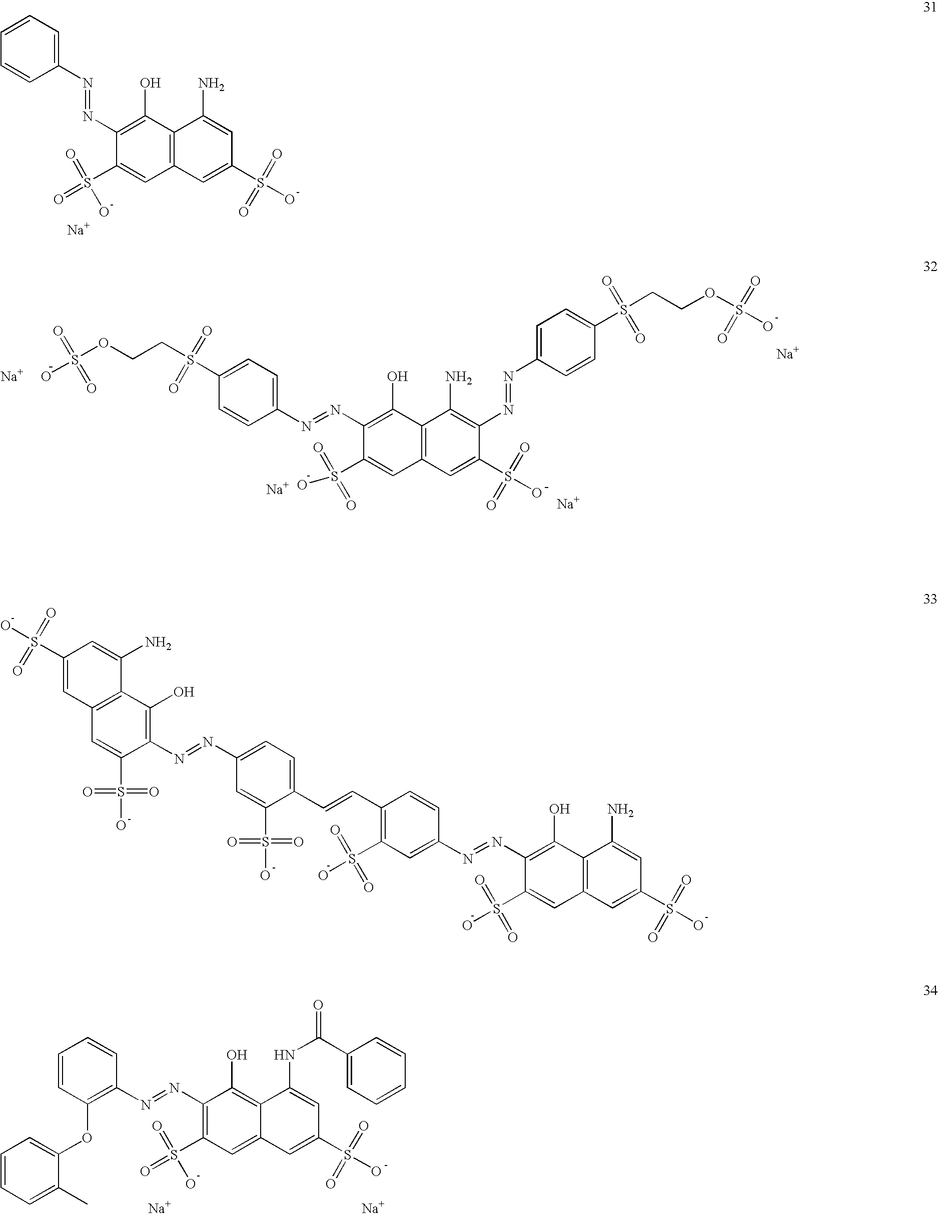

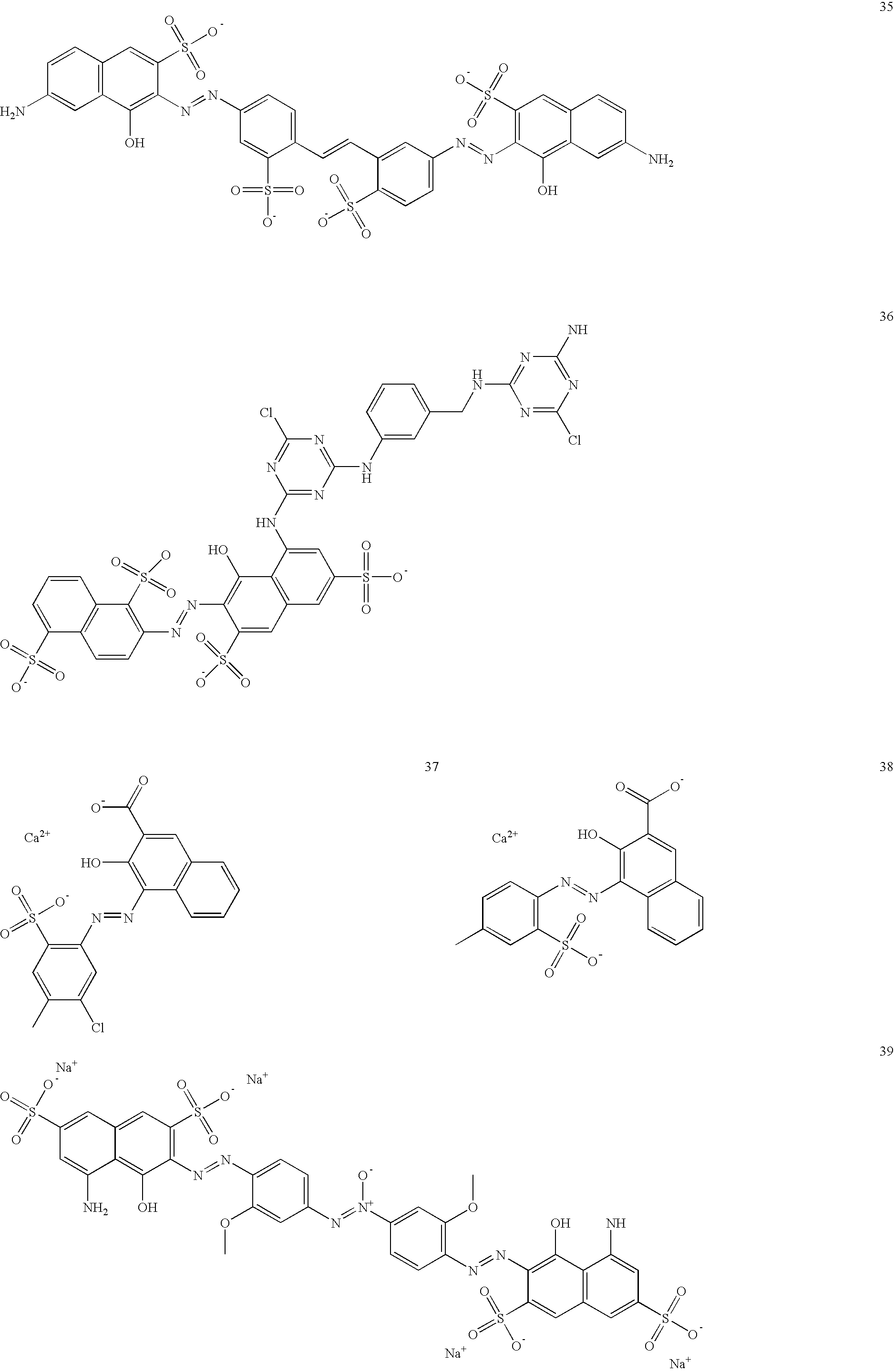

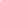

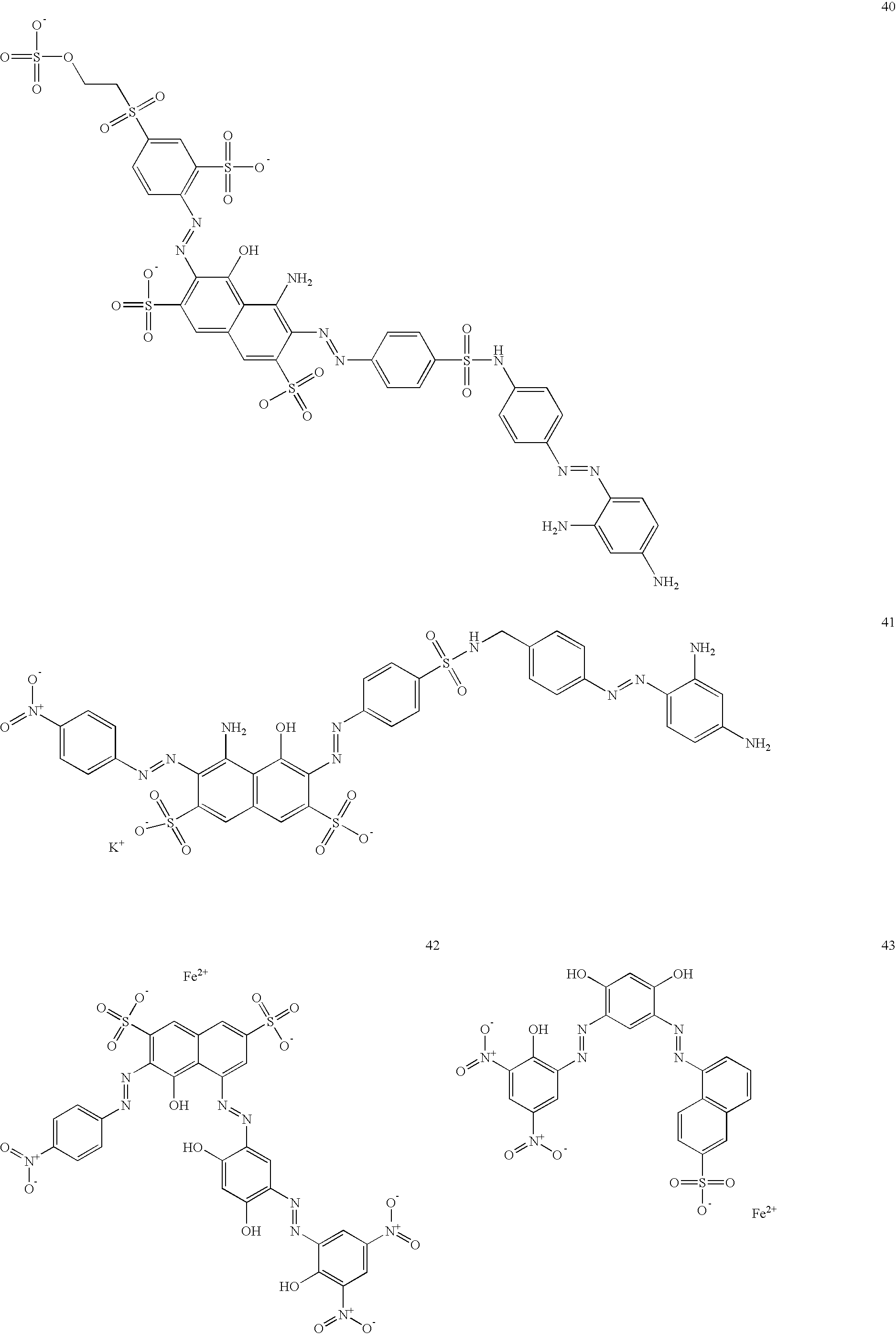

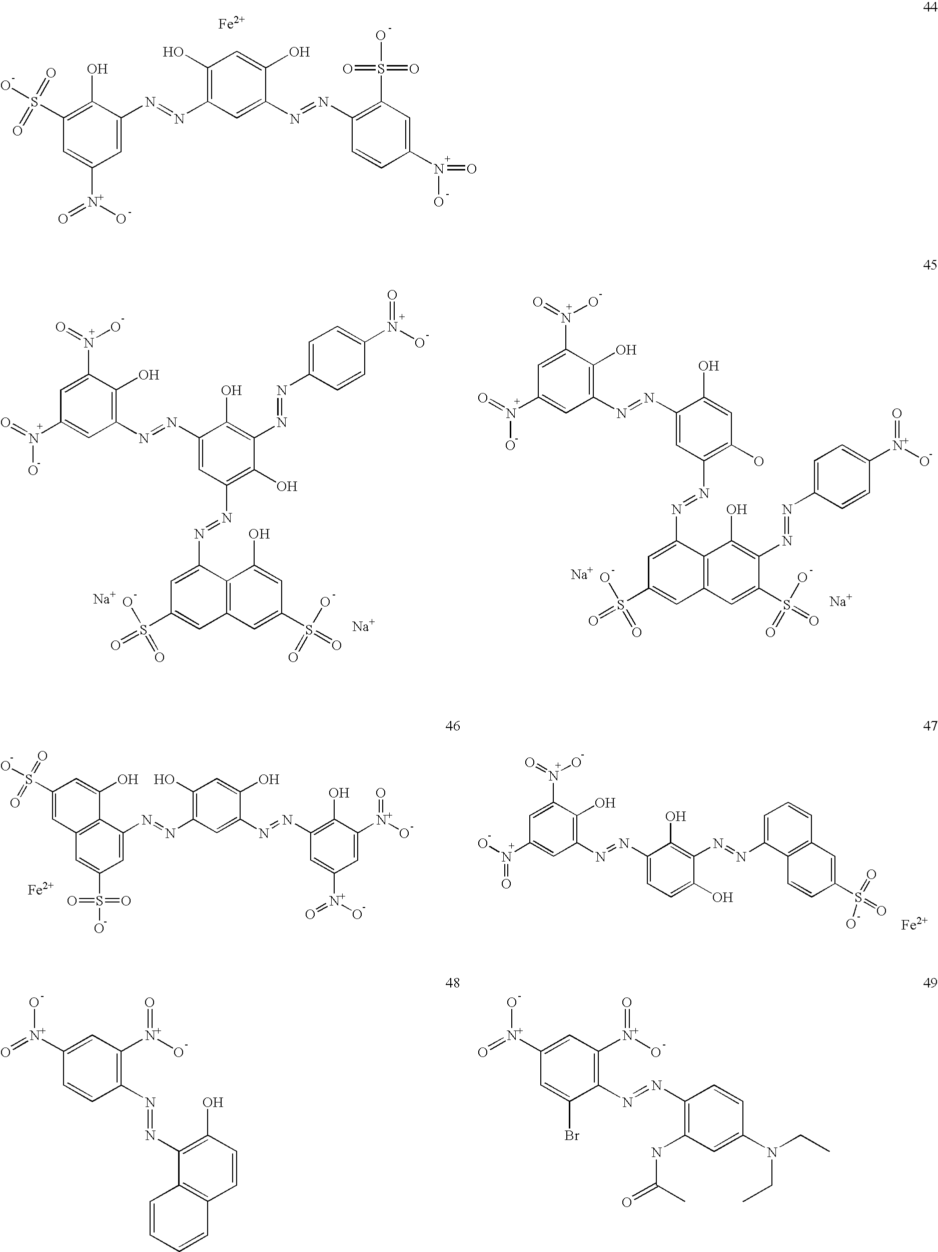

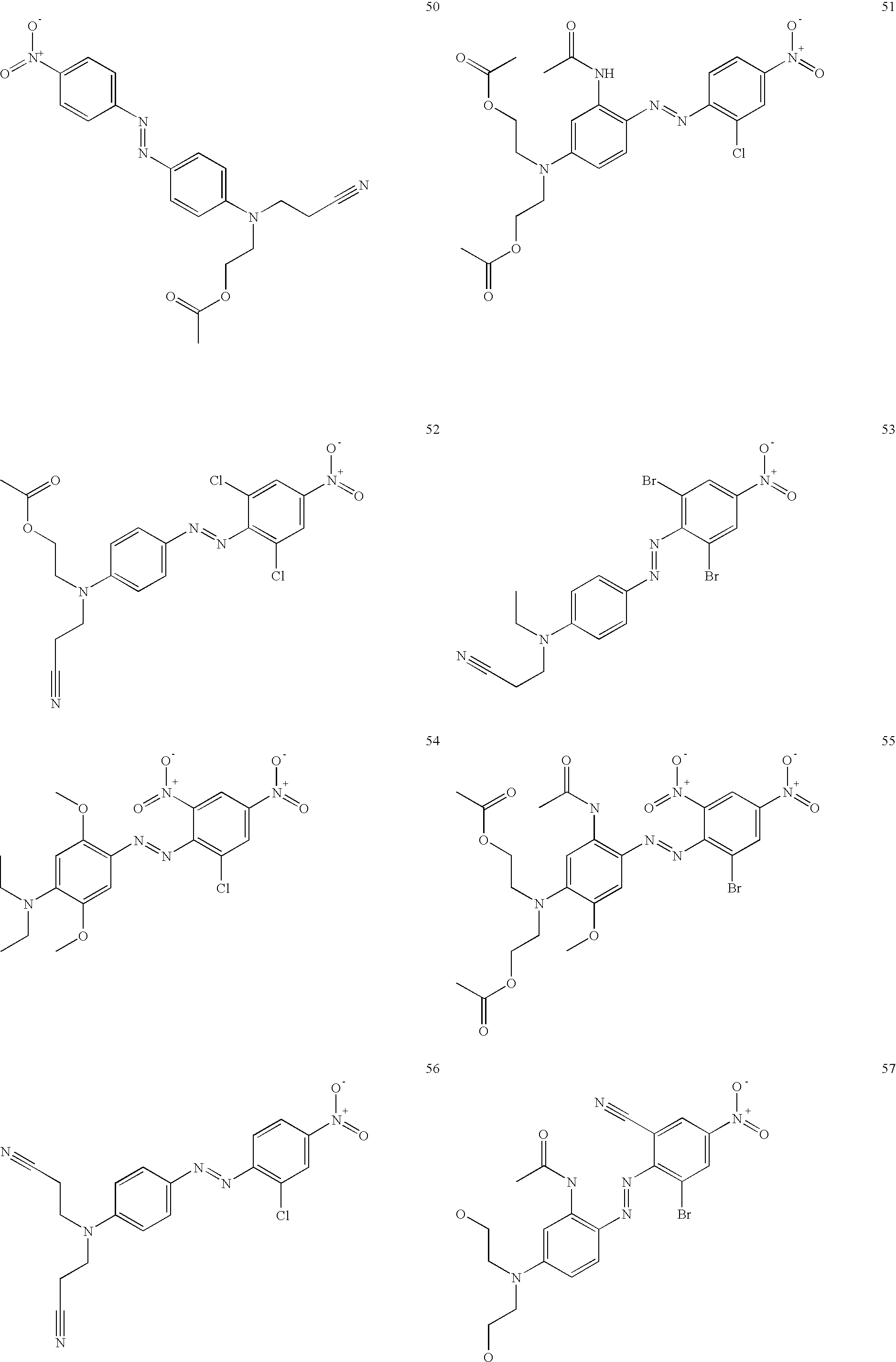

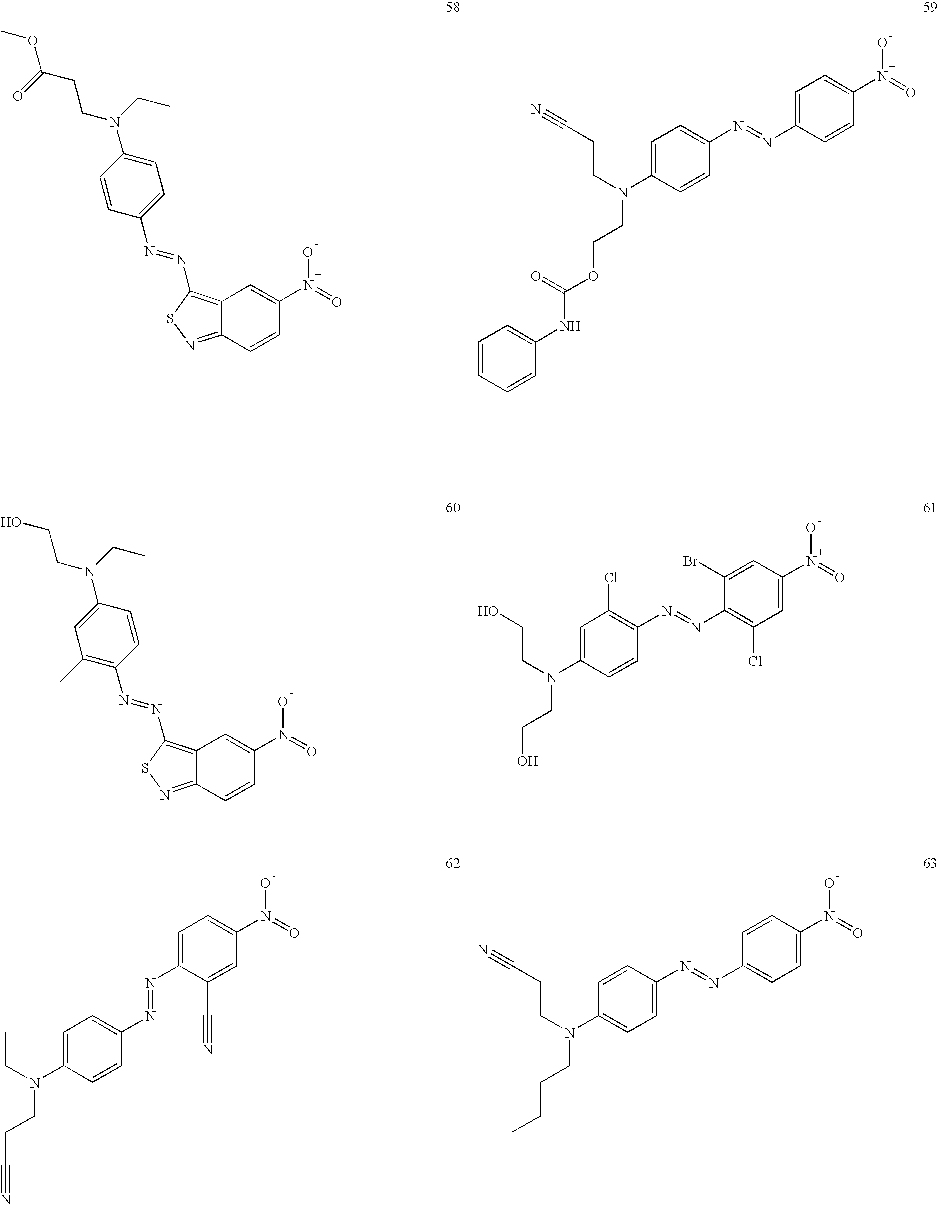

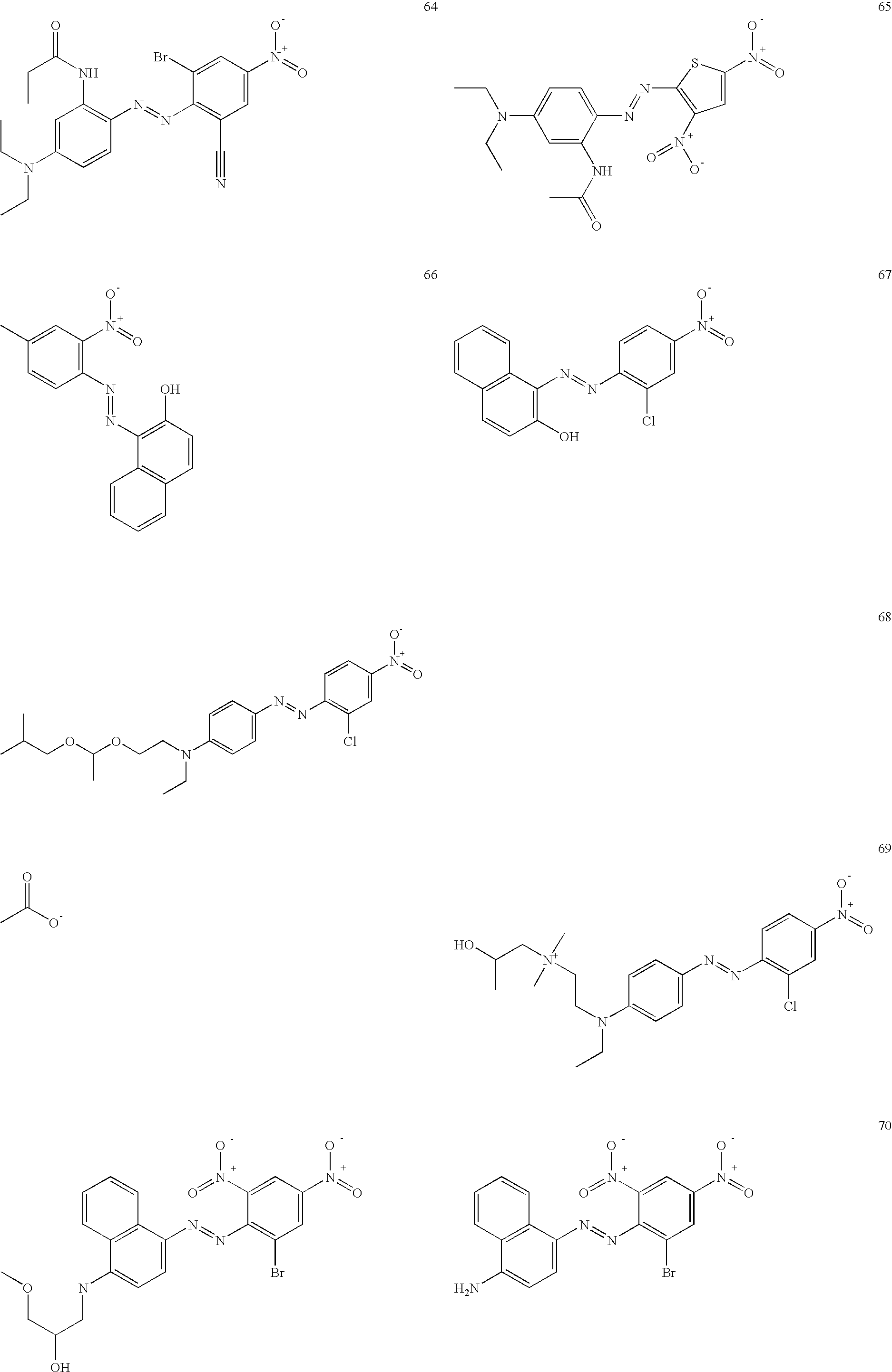

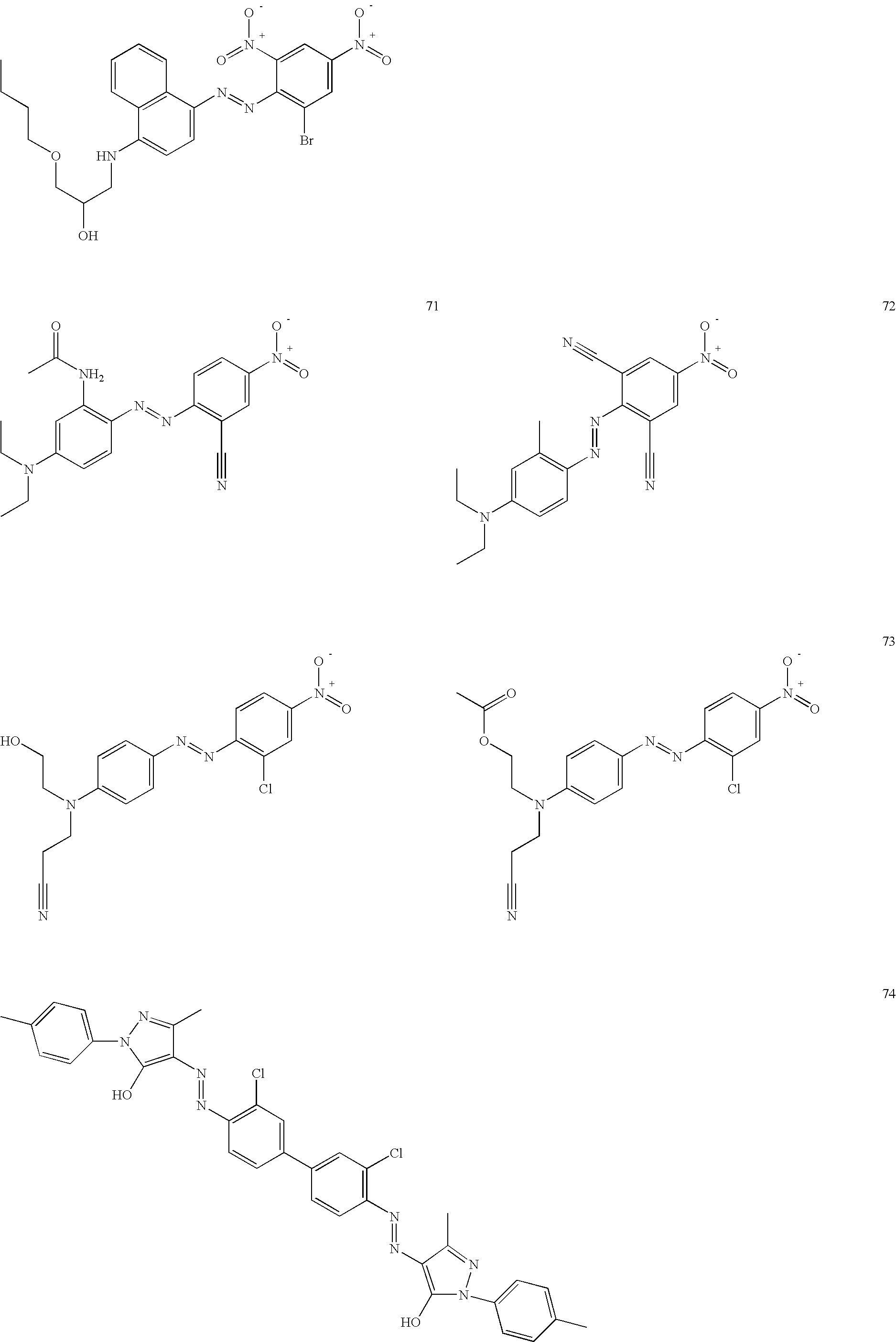

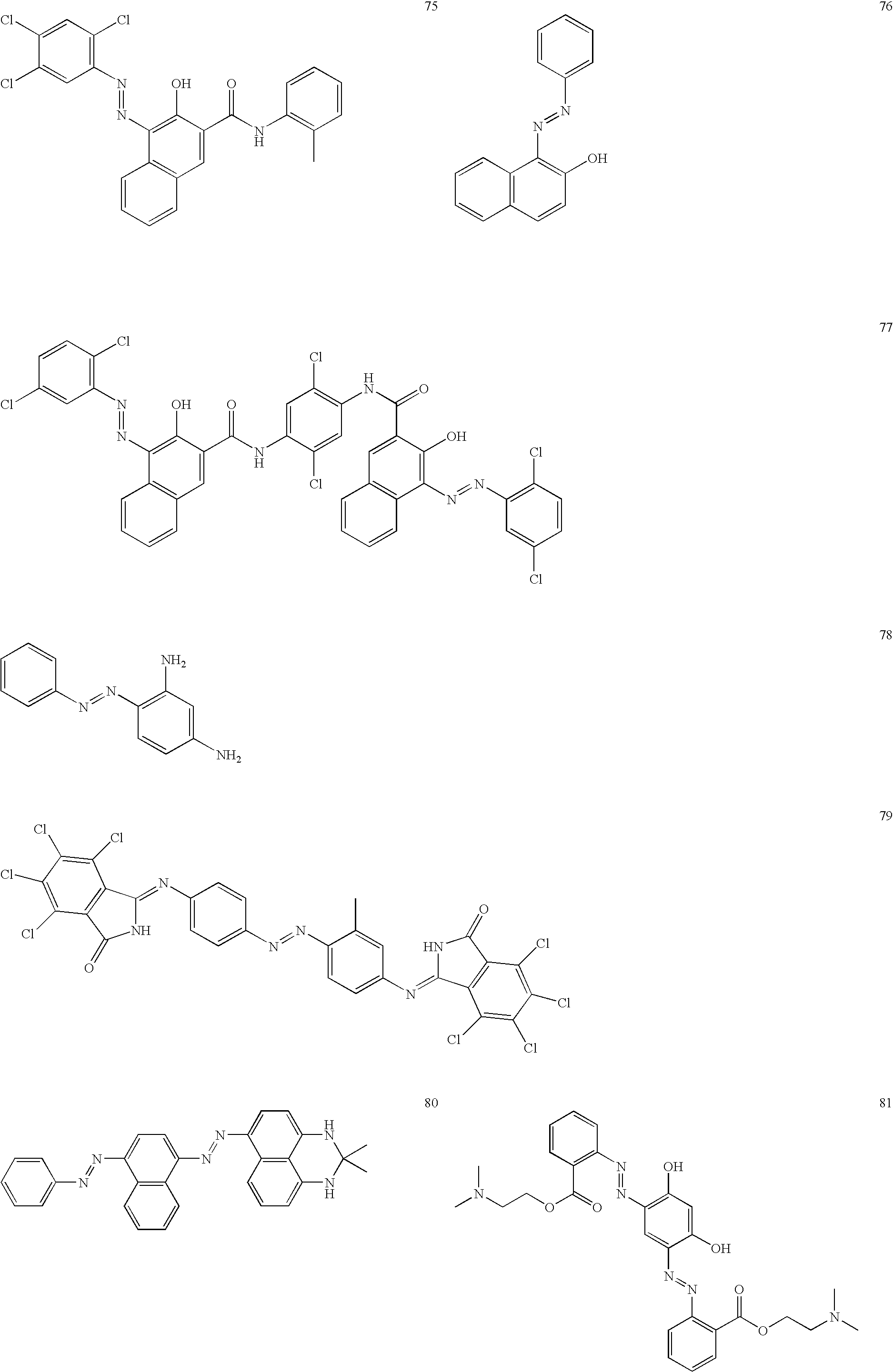

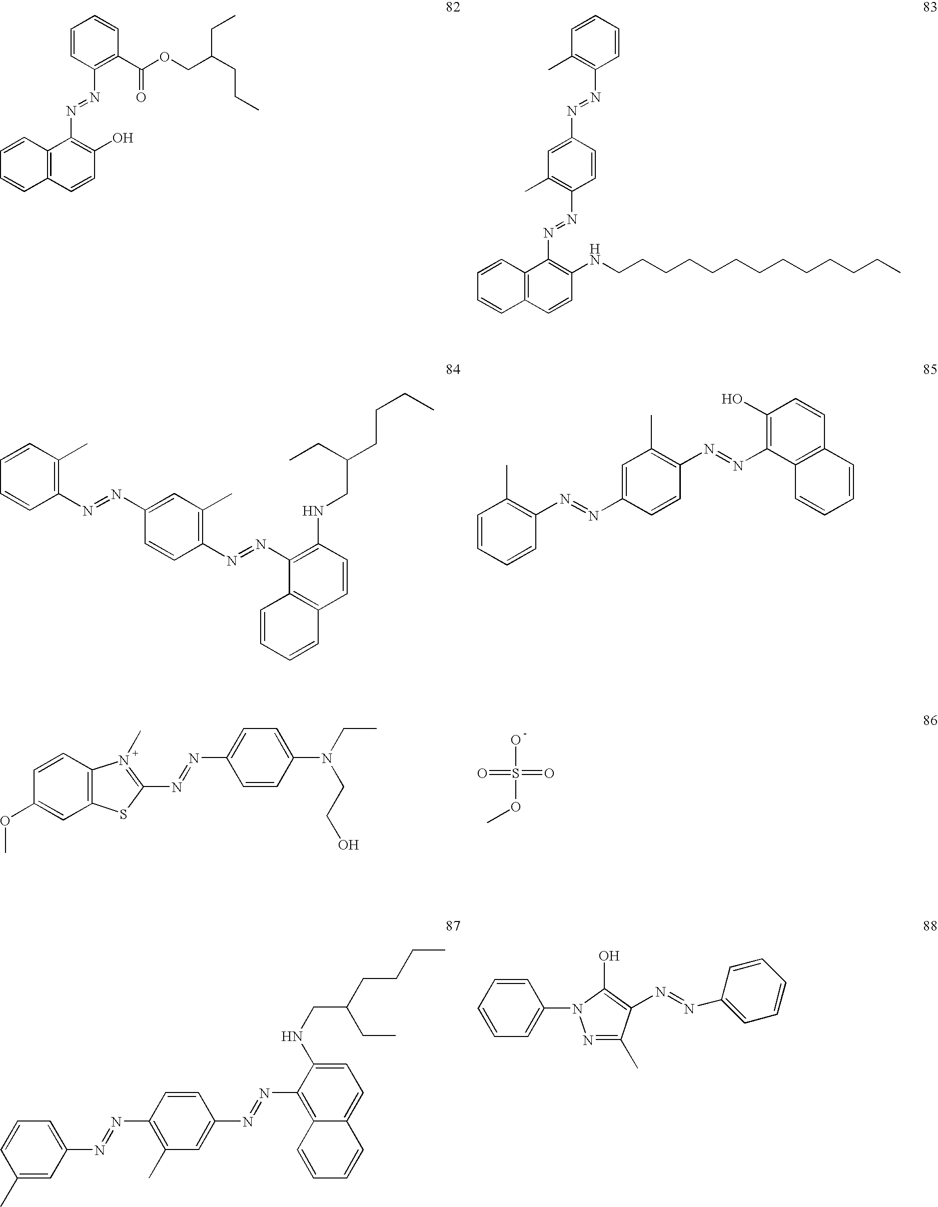

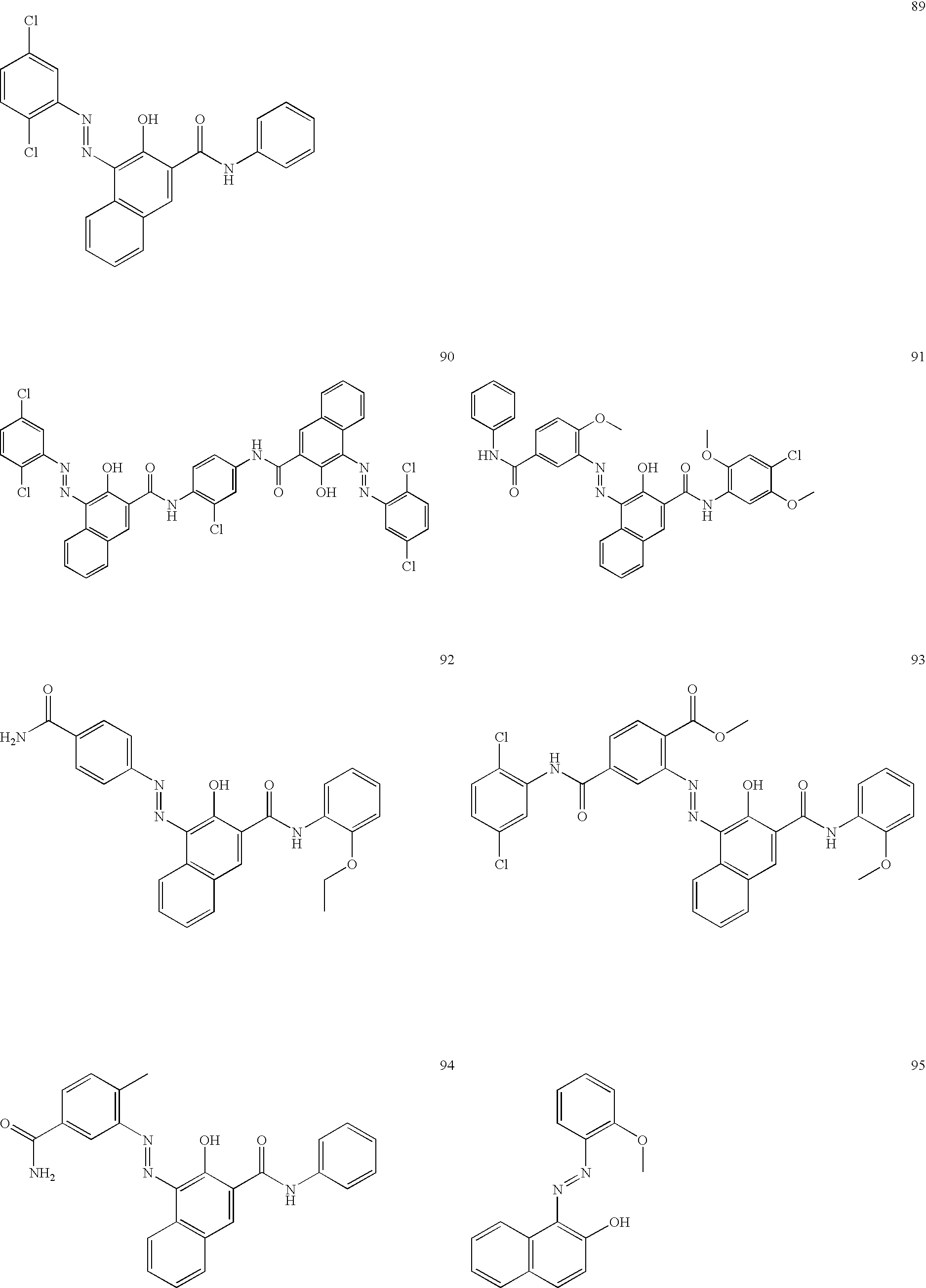

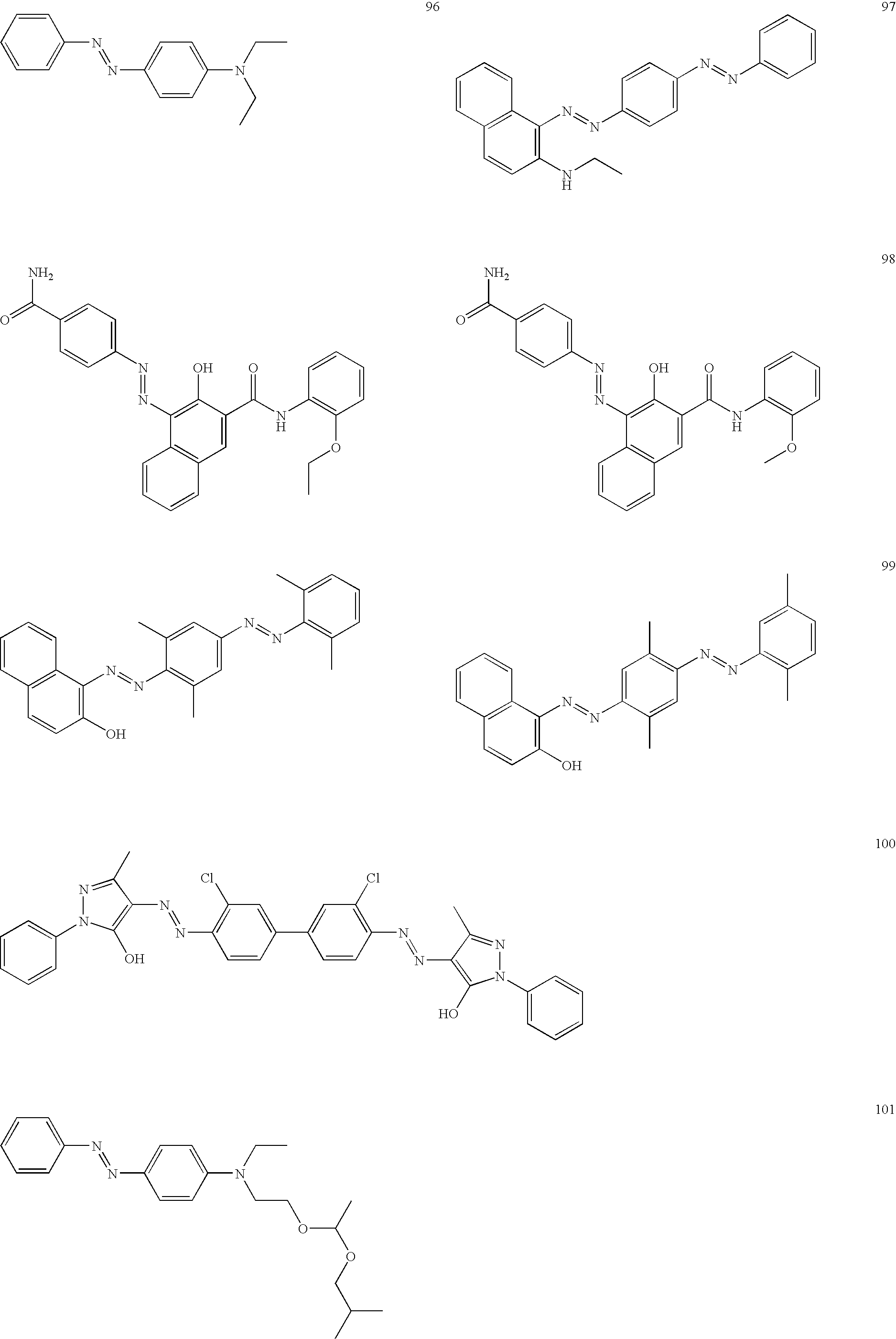

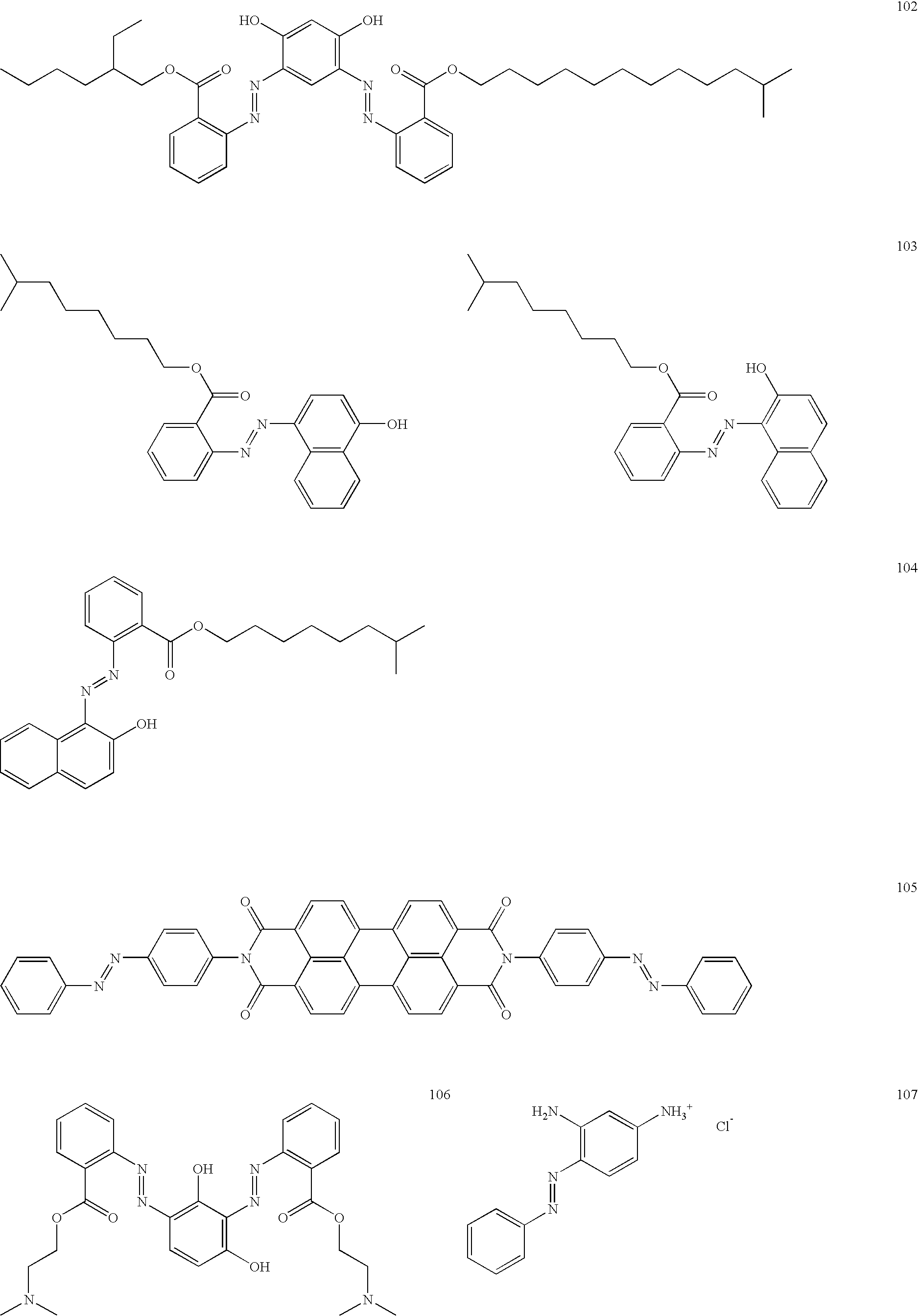

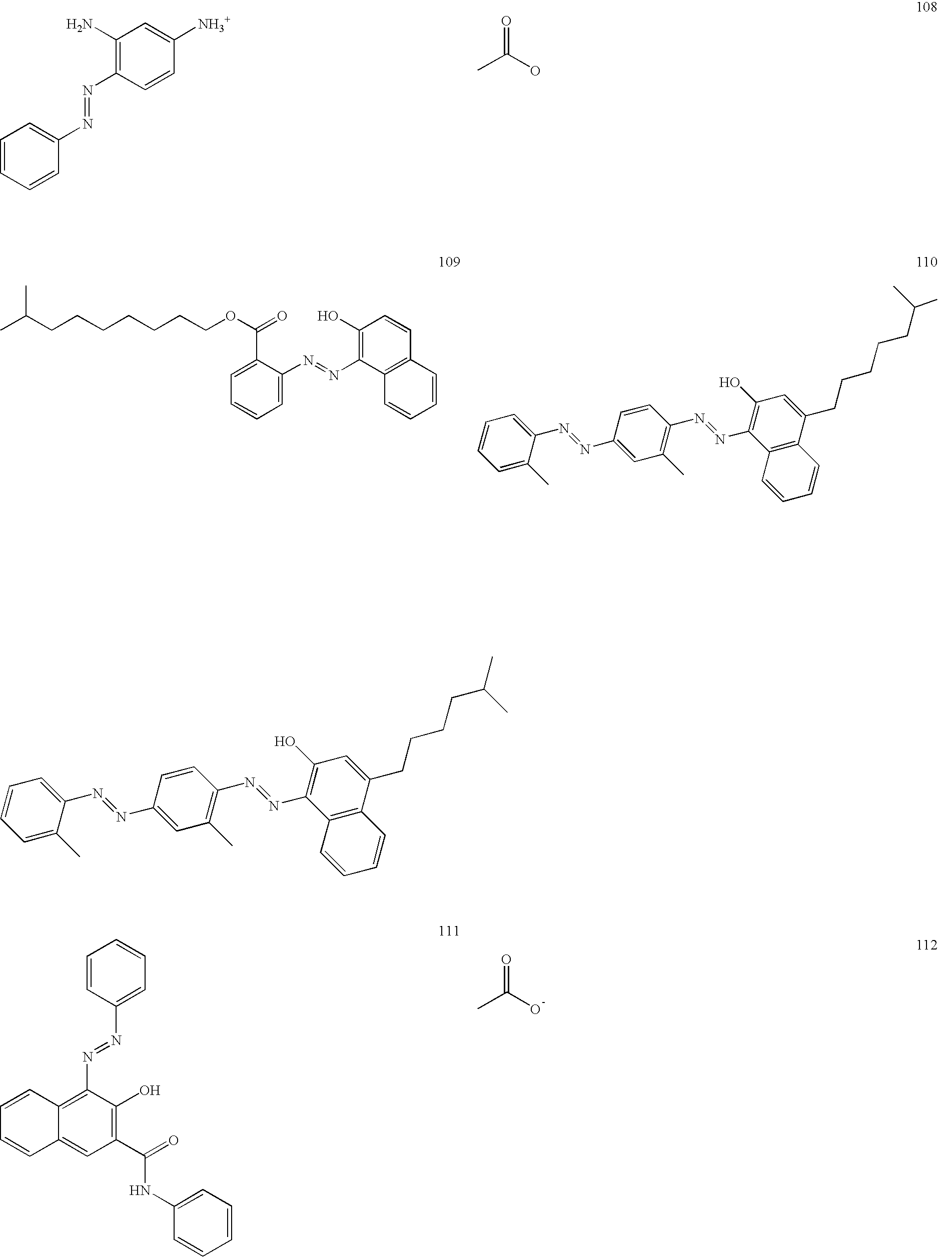

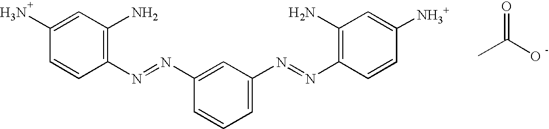

Preferably, the azo compound is selected from the group consisting of the azo compounds 1, 3, 5, 6, 30, 78, 59 and 112, and, in particular, 1 (=E123), 3 (=E10), 5 (=E128) and 6 (=E129):

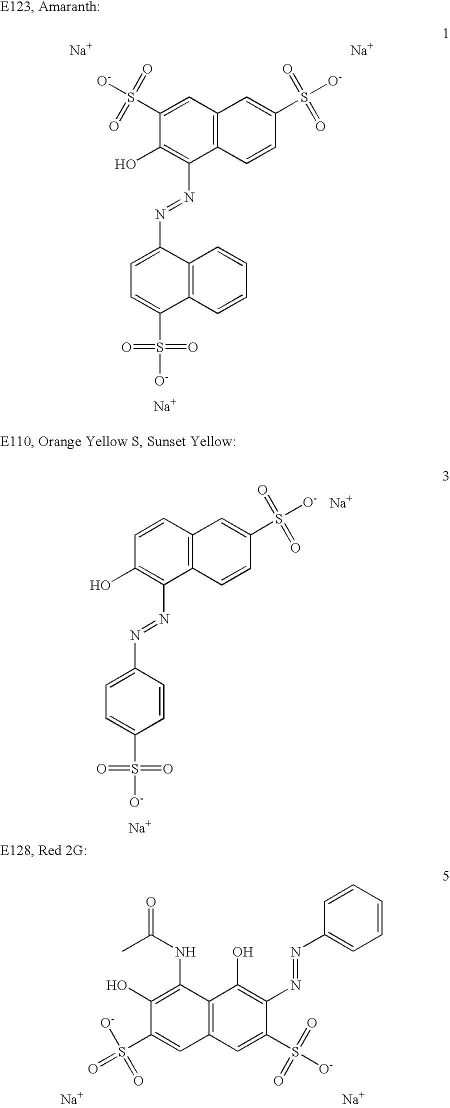

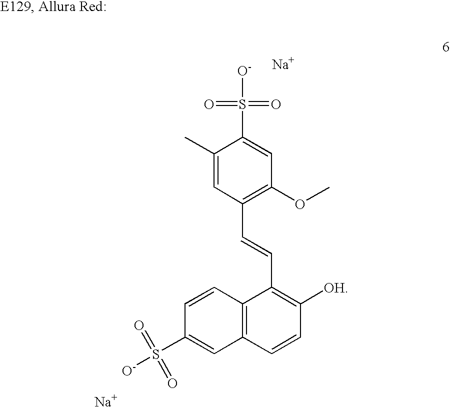

In this case the combinations hereinafter of two preferred azo compounds are particularly advantageous: E110/E128, E110/E129, E128/E129, E123/E110, E123/E128 and E123/E129, in particular E110/E129.

Very particularly preferably, these are a sugar free composition which comprises ACK, and the combination of the two azo compounds E110 and E129.

Apart from the above-described azo compounds to be used according to the invention, other conventional and known taste-modulating substances can also be used in effective amounts. Examples of suitable conventional and known taste-modulating substances are those described at the outset.

### Examples and Comparative Experiments

### Examples 1 and 2

The use of two azo dyes for taste modulation of ACK

For Examples 1 and 2, the substances hereinafter were used.

HIS:

Acesulfame K (ACK) from Fluca Bio Chemika;

Azo Compounds:

No. 3: E110, Sunset Yellow from Sigma;

No. 6: E129, Allura Red from Sigma;

Cola Drink:

What was termed “zero cola” without sweetener was produced as follows:
36 g of cola flavor (cola base from Döhler, Darmstadt, article no. 200380),
7.7 g of orthophosphoric acid 85% ultrapure (Karl Roth GmbH+Co KG, Karlsruhe, article no. 9079.1),
3.6 g of citric acid 99.5% p.a. (Karl Roth GmbH+Co KG, Karlsruhe, article no. 3958.2),
2.4 g of sodium benzoate from Fluka, Sigma-Aldrich, Steindrunn, and
1.2 g of caffeine, anhydrous, 99% from Fluka, Sigma-Aldrich, Steindrunn

were dissolved in 600 ml of tap water. 50 ml portions of this concentrate were made up in each case to one liter of “zero cola”.

Quantitative Sensory Testing—General protocol:

Consensus profiles of samples 1 and 2 of Examples 1 and 2 and also of control samples 1 and 2 were prepared in agreement with DIN 10967-2/ISO 11035. For this, 8 trained testers which had been selected in accordance with the DIN/ISO provisions were made familiar with the products by definition and training of the predetermined feature properties. Subsequently, the testers tasted the samples 1 and 2 in order to assess the taste, aftertaste and mouth feel in accordance with the given feature properties. The respective consensus profiles were summarized by the test leader in the form of tables and spider's web diagrams. Hereinafter, for the sake of clarity, only the tables are reproduced.

Samples 1 and 2 and control samples 1 and 2—composition of matter:

Samples 1 and 2 and the control samples 1 and 2 had the compositions of matter described hereinafter. The respective abbreviations which are used in the tables hereinafter are given in brackets.

Control Sample 1:

Water+500 mg/l of ACK (abbreviation: water/ACK)

Control Sample 2:

Zero cola+500 mg/l of ACK (abbreviation: cola/ACK)

Sample 1—Example 1:

Water+500 mg/l of ACK+2.3 mg/l of azo compound E110+2.5 mg/l of azo compound E129

(abbreviation: water/ACK/E110/E129)

Sample 2—Example 2:

Zero cola+500 mg/l of ACK+2.3 mg/l of azo compound E110+2.5 mg/l of azo compound E129

(abbreviation: cola/ACK/E110/E129)

Samples 1 and 2 and control samples 1 and 2—experimental results:

The results of the quantitative sensory testing of sample 1 and of control sample 1 are summarized in Table 1.

The results of the quantitative sensory testing of sample 2 and control sample 2 are summarized in Table 2.

In both tables, the measurement 0 means that the relevant sensory property was not present, while the measurement 10 denotes that the relevant sensory property was strongly present.

TABLE 1
Quantitative sensory testing of sample 1
and control sample 1 - consensus profile

| Control sample/ | Taste | | Mouth feel | | | | Aftertaste | |
|---|---|---|---|---|---|---|---|---|
| sample | S^{a)} | Bt^{b)} | C^{c)} | K^{d)} | Bl^{e)} | A^{f)} | S(N)^{g)} | Bt(N)^{h)} |
| Control sample 1 | | | | | | | | |
| Water/ACK | 6 | 4 | 4 | 0 | 4 | 2 | 3 | 6 |
| Sample 1 | | | | | | | | |
| Water/ACK/ | 5 | 0 | 4 | 0 | 4 | 2 | 2 | 0 |
| E110/E129 | | | | | | | | |

^{a)}S = sweet;
^{b)}Bt = bitter;
^{c)}C = chemical;
^{d)}K = prickly;
^{e)}Bl = coating;
^{f)}A = drying;
^{g)}S(N) = sweet aftertaste;
^{h)}Bt(N) = bitter aftertaste;

The results of Table 1 show that the two azo compounds E110 and E129 have such a strong taste-modulating effect that the bitter taste and the bitter aftertaste of ACK in water was no longer present.

TABLE 2
Quantitative sensory testing of sample 2 and control sample 2 - consensus profiles

| Control probe/ | Taste | | | | | | Mouth feel | | | Aftertaste | | |
|---|---|---|---|---|---|---|---|---|---|---|---|---|
| Probe | BS^{a)} | Sä^{b)} | Bt^{c)} | KC^{d)} | M^{e)} | Co^{f)} | S^{g)} | A^{h)} | Blⁱ⁾ | Au^{j)} | S(N)^{k)} | Bt(N)^{l)} |
| Control sample 2 | | | | | | | | | | | | |
| cola/ACK | 1 | 6 | 4 | 4 | 2 | 4 | 4 | 2 | 4 | 3 | 3 | 1 |
| Sample 2 | | | | | | | | | | | | |
| cola/ACK/ | 0.5 | 7 | 2 | 6 | 2 | 2 | 3 | 2 | 3 | 4 | 3 | 0 |
| E129/E110 | | | | | | | | | | | | |

^{a)}BS = beginning of sweetness;
^{b)}Sä = acidic;
^{c)}Bt = bitter;
^{d)}KC = artificial/chemical;
^{e)}M = metallic;
^{f)}Co = cola;
^{g)}S = sweet;
^{h)}A = astringent;
ⁱ⁾Bl = coating;
^{j)}Au = drying;
^{k)}S(N) = sweet aftertaste;
^{l)}Bt(N) = bitter aftertaste;

The results of Table 2 show that, using the two azo compounds E110 and E129, the bitter taste and the bitter aftertaste of ACK in cola were able to be significantly reduced.

1-19. (canceled)

20. A process for modulating the taste of a composition of matter which comprises at least one High Intensity Sweetener (HIS) comprising adding at least two azo compounds in a total concentration of from 0.1 to 30 ppm or from 0.1 to 30 mg/l as taste modulators to said composition of matter which comprises at least one HIS.

21. The process of claim 20, wherein said composition of matter which comprises at least one HIS is a food, drink, article consumed for pleasure, sweetening agent, animal feed, cosmetic, or pharmaceutical.

22. The process of claim 20, wherein said at least one HIS is selected from the group consisting of acesulfame-potassium, aspartame, saccharin and salts thereof, cyclamate and salts thereof, aspartame-acesulfame salt, sucralose, thaumatin, stevia, stevioside, and neohesperidin dihydrochalcone.

23. The process of claim 22, wherein said at least one HIS is acesulfame-potassium.

24. The process of claim 20, wherein two azo compounds are added.

25. The process of claim 20, wherein said at least two azo compounds each comprise at least one azo group.

26. The process of claim 20, wherein said at least two azo compounds are water soluble.

27. The process of claim 20, wherein the azo groups of said at least two azo compounds are linked to aryl groups and/or to aryl groups having heteroatoms.

28. The process of claim 27, wherein the azo groups of said at least two azo compounds are linked to aryl groups.

29. The process of claim 28, wherein said aryl groups are phenyl groups and naphthyl groups.

30. The process of claim 27, wherein at least one of said aryl groups is substituted at least once with a substituent.

31. The process of claim 30, wherein said substituent is selected from the group consisting of sulfonic acid groups, nitro groups, alkyl groups, carboxyl groups, hydroxyl groups, ester groups, ether groups, primary and secondary amino groups, amido groups, nitrile groups, and halogen atoms.

32. The process of claim 31, wherein said substituent is a sulfonic acid group and/or a hydroxyl group.

33. The process of claim 20, wherein said at least two azo compounds are selected from the group consisting of E110, E123, E128, and E129:

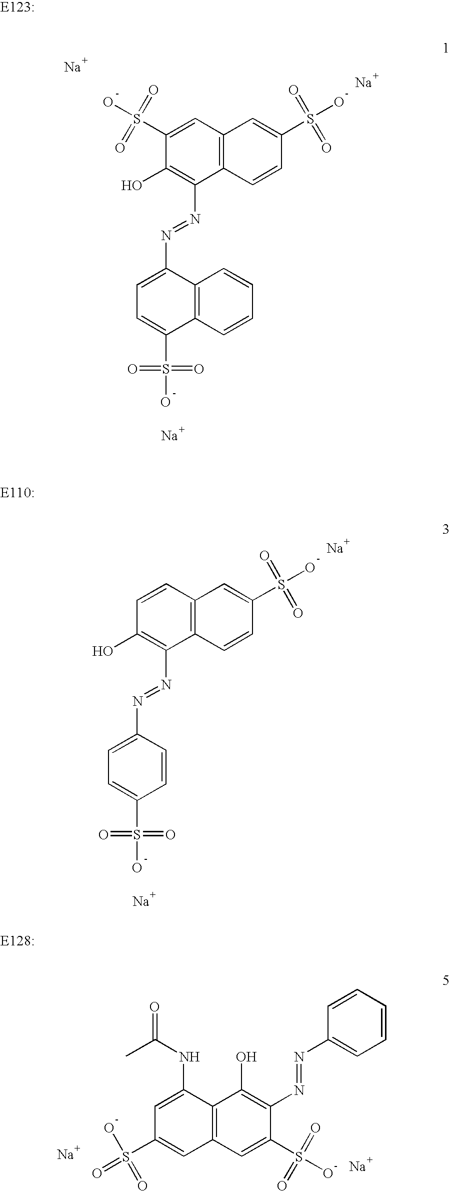

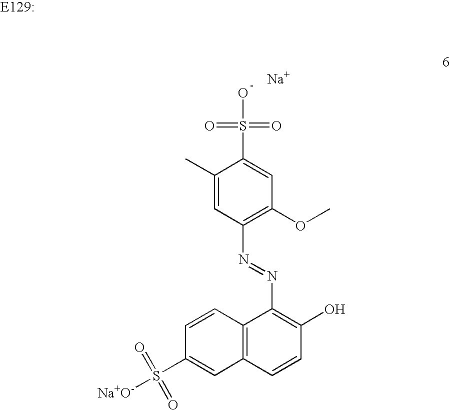

34. The process of claim 33, wherein said at least azo compounds are E110 and E129.

35. The process of claim 20, wherein said process results in the reduction of the bitter taste and the bitter aftertaste of said composition of matter which comprises at least one HIS.

36. The process of claim 20, wherein said composition of matter which comprises at least one HIS is a low-sugar composition.

37. The process of claim 36, wherein said composition of matter which comprises at least one HIS is a sugar-free composition.

38. The process of claim 20, wherein said composition of matter which comprises at least one HIS is a drink.

39. The process of claim 38, wherein said composition of matter which comprises at least one HIS is a caffeine-comprising drink.

40. The process of claim 20, wherein said composition of matter which comprises at least one HIS is a carbohydrate-free composition.
